(19) United States
(12) Patent Application Publication
(10) Pub. No.: US 2022/0190503 A1
(43) Pub. Date: Jun. 16, 2022

(54) ELECTRICAL CONTACT ASSEMBLY

(71) Applicants: FRAUNHOFER-GESELLSCHAFT ZUR FÖRDERUNG DER ANGEWANDTEN FORSCHUNG E.V., München (DE); Carl Haas GmbH, Schramberg (DE)

(72) Inventors: Thomas SCHRIEFER, Effeltrich (DE); Maximilian HOFMANN, Erlangen (DE); Nico MOOSMANN, Schramberg (DE); Andreas DEIBERT, Schramberg (DE); Thorsten GERBERICH, Schramberg (DE)

(73) Assignees: Fraunhofer-Gesellschaft Zur Foerderung Der Angewandten Forschung E.V., Muenchen (DE); Carl Haas GmbH, Schramberg (DE)

(21) Appl. No.: 17/425,781

(22) PCT Filed: Jan. 27, 2020
(86) PCT No.: PCT/EP2020/051901

§ 371 Date: Jul. 26, 2021

(30) Foreign Application Priority Data
Jan. 28, 2019 (DE) 10 2019 201 017.2
May 27, 2019 (DE) 10 2019 207 737.4

(51) Int. Cl. H01R 13/187; H01R 4/48; H01R 13/17

(52) U.S. Cl. CPC H01R 13/187; H01R 13/17; H01R 4/4863

(57) ABSTRACT

An electrical contact assembly, in which a first and a second contact element are electrically insulated from one another by at least one insulation element or an electrically insulating coating. In both contact elements, a through hole is formed, into each a pin can be introduced. On the first contact element and/or the first pin and the inner lateral surface of the second contact element and/or the outer lateral surface of the second pin, a groove-shaped depression is formed, having at least one annular spring element inserted which is formed from an electrically conductive and elastically deformable material, it is geometrically formed and dimensioned such that the wall facing radially outwards and/or radially inwards acts with a pressure force against the surface of a pin and the surface of the contact elements in a groove-shaped depression. The contact elements and pins are connected to an electrical voltage source.

### BACKGROUND OF THE INVENTION

The invention relates to an electrical contact arrangement for separating and connecting the electrical poles of an electrical voltage source to an electrical load. A coaxial arrangement can set current paths with low inductance, which can ensure an electrically conductive connection that has low resistance, high current resistance and tolerance flexibility in multiple contact points.

It can be used in power electronics, wherein load or auxiliary connection ports are implemented via spring elements in order to increase tolerance flexibility and to reduce the commutation inductance of a power semiconductor module.

Resilient elements are usually used to compensate for geometric differences, manufacturing tolerances and/or occurring mechanical vibrations in order to enable a reliable electrical current flow.

The surface topology of the contact surfaces, via which an electrical current can flow, plays a major role in reducing electrical losses and avoiding high electrical contact resistance.

In addition, it should be possible to take into account any generated tolerance shifts or micro-movements occurring during operation in order to reduce increased or irregular electrical contact resistances.

Each electrical conductor through which current flows forms a magnetic field which induces an electrical voltage in the surrounding electrical lines of a second electrical pole and counteracts the electrical current flow. This negative effect is determined by the spanned area of the magnetic field. The performance of contacted electrical components is thus also impaired, which impaired electrical components are associated with steep electrical current increases or short switching times in order to avoid dynamic voltage peaks during a switching operation. The areas spanned by supply lines through which current flows should therefore be minimized in order to enable a low-inductance connection of electrical components.

### SUMMARY OF THE INVENTION

It is therefore the object of the invention to propose an electrical contact arrangement which has low inductance and low resistance and can compensate for mechanical operating and manufacturing tolerances.

According to the invention, this object is achieved with an electrical contact arrangement having the features the claims.

In the invention, a first contact element and a second contact element, which are arranged electrically insulated from one another by means of at least one insulation element or an electrically insulating coating formed on the surface of at least one of the contact elements, are present.

In this case, a through hole is formed in each of the first and second contact elements, into which through hole a first mandrel and a second mandrel can be inserted.

A groove-shaped recess is each formed on the first contact element and/or the first mandrel and the inner shell of the second contact element and/or the outer shell of the second mandrel, in each of which at least one ring-shaped spring element, particularly a helical spring, the face-side ends of which are interconnected, can be used in a form-fitting manner. If a groove-shaped recess is formed both in a mandrel and in a through hole of a contact element, a groove-shaped recess of such a recess pair should be dimensioned smaller than the respective other groove-shaped recess.

A ring-shaped spring element should be formed hollow on the inside, particularly cylindrical or else elliptical in form having an inner and outer diameter that is constant over its length and a constant cross-section when it is in an unloaded state. The ring-shaped spring element does not necessarily have to be cylindrical in form.

The at least one ring-shaped spring element in each case is formed from an electrically conductive and elastically deformable material. Its inner and outer dimensions, particularly the windings of a helical spring, are geometrically designed and dimensioned such that the radially outward and/or the radially inward-facing wall act against the surface of the respective mandrel and the surface of the first and second contact element in the region of a respective groove-shaped recess with the application of compressive force when the mandrels are inserted into the through holes to produce an electrically conductive connection.

The first electrical contact element or the first mandrel is connected to one pole of an electrical voltage source and the second electrical contact element or the second mandrel is connected to the respective other pole of the electrical voltage source. Depending on whether an electrical contact element or the associated mandrel is connected to a pole of an electrical voltage source, either the respective mandrel or the respective electrical contact element that is not connected to the electrical voltage source can be connected to a pole of an electrical load in an electrically conductive manner.

The groove-shaped recesses should be dimensioned such that a spring connpression of at least 10%, preferably of at least 20% and a maximum of 30% compared to the original state of the ring-shaped spring element is achieved when the mandrels are inserted into the through holes of the first and second contact elements. The ring-shaped spring elements can thus be deformed elliptically. Compressive forces can thus act between the surfaces of the electrical contact elements and the mandrels, such that reliable electrical current flow can be achieved via the electrical contact elements, the ring-shaped spring elements and the mandrels, since a temporary lifting of the ring-shaped spring elements, particularly the windings of helical springs, from the respective surfaces used for electrical conduction can be reliably avoided even with mechanical, particularly vibrating, loading. Surfaces of ring-shaped spring elements can thus rest on the surface of at least one groove-shaped recess and one oppositely arranged surface at any time and thus ensure a low-resistance current flow. The deformation of the ring-shaped spring elements can also increase the contact surface that can be used for the electrical current flow. The contact forces acting there can also compensate for roughness peaks on the surfaces.

The groove-shaped recesses should advantageously be designed as concave, trapezoidal or V-shaped grooves. The choice of the radius of the respective groove-shaped recess should take into account the shape and dimensions of the respective compressed ring-shaped spring element when the electrical contact arrangement is in a state in which an electric current flows through the two ring-shaped spring elements.

The concave, trapezoidal or V-shaped groove increases the surface that can be used for an electrical current flow. It also supports a mechanical lock. Regardless of the recess radius selected in each case, there is at least one contact point, which is advantageous since flat contacts in practice require contact forces which normally cannot be realized technically or which require very high assembly forces. Although there is actually only one contact point, elastic material deformation forms contact fingers in the region of many roughness peaks on the surface, through which an electrical current can flow. Flat contacts require contact forces that cannot be realized in practice. A circular cross-section having a plurality of contact-finding roughness peaks can be formed by elastic material deformation when contact is made from one or more contact point(s). Particularly, a plurality of contact points result when groove-shaped recesses are formed in a V-groove shape. In addition, the path for the electrical current flow can thus be shortened.

In an alternative, a groove-shaped recess can be formed in the region of the inner shell of the through hole of the first contact element. In a further alternative, a groove-shaped recess can also be formed on a surface of the first electrical contact element, which surface is arranged in the direction of a circumferential flange that is formed on the first mandrel. In turn, as an alternative to this, a groove-shaped recess can also be present on a surface of a flange which is part of the first mandrel and this surface is arranged in the direction of a surface of the first electrical contact element. If the mandrel is inserted into the through hole of the first electrical contact element in one of these alternatives, a deformation of the ring-shaped spring element arranged in the correspondingly arranged groove-shaped recess, as explained above, can be achieved by maintaining a corresponding force on the first mandrel, which force presses said first mandrel axially against the corresponding surface of the first electrical contact element, or can be achieved solely due to gravitational forces due to the first mandrel's own weight.

One or more axially tiltable or already tilted helical spring(s) can be used as ring-shaped spring elements in the groove-shaped recess(es). Helical springs, the coils of which have an oval shape, can also be used.

In the case that a groove-shaped recess is formed both in a mandrel and in a through hole of a contact element, one of the groove-shaped recesses of such a recess pair can be dimensioned smaller than the respective other grooveshaped recess. On the one hand, this has the advantage that the electrical connection can be separated easily by a translatory movement of the respective mandrel, without loosening the form-fitting connection of the respective ring-shaped spring element with the corresponding contact element or the respective mandrel on which the deeper groove-shaped recess is present. On the other hand, a larger surface can be used with a pair of groove-shaped recesses, which surface is available for an electrical current flow through the respective ring-shaped spring element(s). The current path can be shortened by means of the cross-sectional shape of a groove-shaped recess.

A mandrel can be made in one piece from a solid material, but also as a hollow cylinder.

An insulation element can be designed in the shape of a sleeve or socket on which a flange pointing radially outward is present. The respective sleeve can be arranged between the outer shell of at least one of the mandrels and the inner shell in the region of one of the two contact elements and the flange can be arranged between the first and second contact elements.

The mandrels and the through holes formed in the contact elements should have a complementary cross-sectional geometry. This can, for example, be rotationally symmetrical, elliptical or polygonal in form. The ring-shaped spring elements can adapt to the respective geometry because of their elasticity.

At least one of the mandrels can be designed in the form of a sleeve or socket, that is, hollow on the inside, particularly a hollow cylinder, into which the respective other mandrel and the sleeve-shaped region of the insulation element can be inserted.

The dimensions and geometrical design of the through holes and of the at least one insulation element should be selected such that the mandrels can be moved in a translatory and sliding manner within the through holes or a sleeve-shaped insulation element during electrical switching operations under electrical load. Tilting is to be avoided as far as possible and a sufficient pressure force effect, which enables a corresponding deformation of the ringshaped spring elements during an electrical current flow through the ringshaped spring elements, is achieved.

To establish and separate an electrically conductive connection, the two mandrels can each be moved individually or together in a translatory manner.

A first mandrel can form an inner conductor and the second mandrel can form an outer conductor.

A mechanical tolerance compensation, which leads to constant electrical contact conditions, is also possible in the moved state using the invention. It represents a coaxial structure of two electrical contact partners, each having a different electrical potential.

A close arrangement of two electrical conduction paths is possible, such that parasitic inductances can be minimized.

An electrical current flows exclusively through the ring-shaped spring elements, particularly the windings of the helical springs, when an electrical current flow is to take place and the mandrels have been positioned accordingly.

The electrical current flow can be influenced by the number of windings, the angle of inclination of the windings, the width and height of the respective winding window and the ratio of its diameter or cross-sectional area size, the material with which the respective helical spring is formed and whether the surface of the spring material is modified or is refined and accordingly also the contact points and the respective winding window of the helical springs and the cross-sectional area of the windings (wire thickness).

There is no time restriction on the power distribution in the line cross-section. Three-phase electrical currents can also be switched.

Scaling for an electrical current flow of high electrical currents >50 A can be achieved due to the possible and influenceable size of the electrical contact area, which can be influenced by means of the number of winding points and the winding cross-sectional area.

When a ring-shaped spring element is deformed, which is held in a form-fitting manner in a groove-shaped recess and compressed by moving a mandrel, the contact surface that can be used for the electrical current flow can be increased. The respective spring compression can be selected within a tolerance-flexible compression range of the characteristic spring characteristic curve of the respective ring-shaped spring element, which can be seen from FIG. 6. During compression, the windings of a helical spring, particularly, can be tilted as a ring-shaped spring element until approximately the middle of the tolerance field has been reached.

The ring-shaped spring elements consist of a metal or another electrically conductive substance or material. The electrical conductivity and the spring constant should be taken into consideration when selecting the spring material. In the case of an alloy, CuCrZn or CuBe₂ can be preferred. In the case of ringshaped spring elements that are subject to high mechanical loads, said spring elements can be formed from or with a stainless steel. It is particularly advantageous to coat the surface in order to avoid or at least hinder oxidation. This can be achieved, for example, using gold, silver, nickel or tin layers.

The electrical contact elements are also electrically conductive and can consist of a suitable metal, for example, copper.

An insulation element can be formed from a polymer or an electrically nonconductive ceramic material.

### DESCRIPTION OF THE DRAWINGS

The invention is to be explained in more detail below by way of example. Individual features that can be found in the examples or figures are not limited to the respective example or figure. Features can be combined with one another regardless of the respective example or figure.

Shown Are:

FIG. 1 a first example of a contact arrangement according to the invention;

FIG. 2 a second example of a contact arrangement according to the invention;

FIG. 3 a third example of a contact arrangement according to the invention;

FIG. 4 a fourth example of a contact arrangement according to the invention;

FIG. 5 a fifth example of a contact arrangement according to the invention and

FIG. 6 a diagram from which one can see a tolerance field for the compression of helical springs.

### DETAILED DESCRIPTION OF THE INVENTION

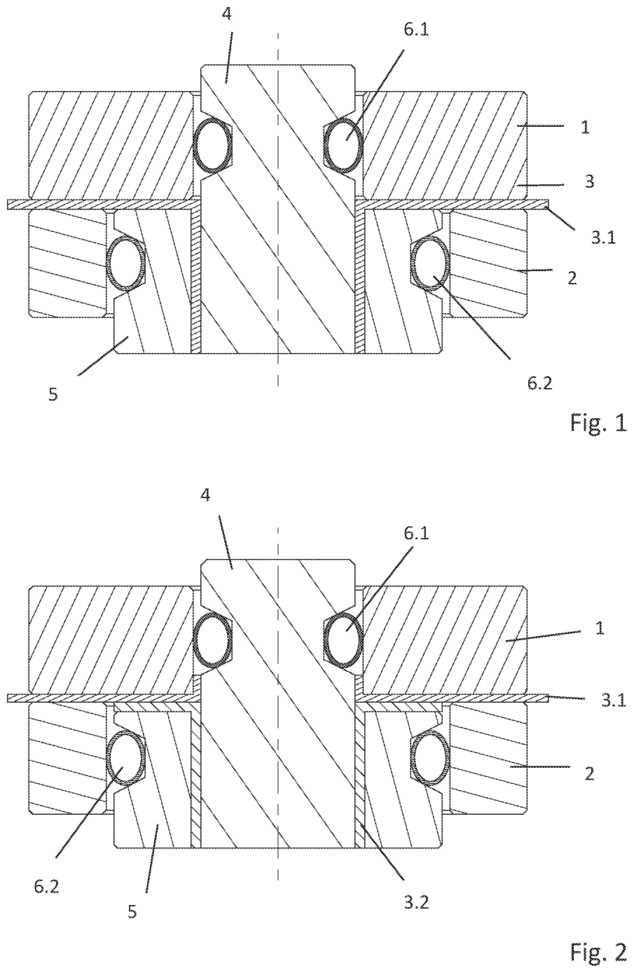

In the example shown in FIG. 1, a ring-shaped electrical contact element 1 is connected in a form (not shown) to a pole of an electrical voltage source. In the contact element 1, a bore is formed as a through hole into which a first mandrel 4 is inserted with clearance. The first mandrel forms the inner conductor. On the outer shell of the first mandrel 4, a groove-shaped recess is formed, into which a helical spring interconnected at the end faces is inserted and held in a form-fitting manner as an example of a ring-shaped spring element 6.1. The groove-shaped recess is dimensioned such that the helical spring 6.1 is securely held and compressed by means of the inner shell of the first contact element 1 in the region of the through hole such that compressive forces between the windings of the helical spring 6.1 and the corresponding surfaces of the first contact element 1 and the first mandrel 4 act and the helical spring 6.1 has been elliptically deformed. The windings of the helical spring 6.1 can also be tilted laterally.

An electrically conductive connection is established in this position of the first mandrel 4. If the first mandrel 4 is moved in a translatory manner in the axial direction, the groove-shaped recess with the first helical spring 6.1 moves into a position in which the helical spring 6.1 no longer has any contact with the first contact element 1 and the electrically conductive connection can thereby be separated.

The electrically conductive connection can also be separated when the first contact element 1 is moved in a translatory manner such that there is no touching contact with the first helical spring 6.1.

In this example, a second contact element 2 is connected to one pole of an electrical voltage source (not shown). A bore is also formed as a through hole in the second electrical contact element 2. To establish an electrically conductive connection, a second mandrel 5 having little clearance can be inserted into this through hole, which in this example is sleeve-shaped in form. A sleeve-shaped insulation element 3.1, in which a circumferential flange is formed on an end face pointing in the direction of the first electrical contact element 1, is guided as electrical insulation to the first mandrel 4 and the first electrical contact element 1 through the interior of the sleeve.

A groove-shaped recess is also formed on the outer shell of the second mandrel 5, into which recess a helical spring has been inserted as an example of a ring-shaped spring element 6.2, analogous to helical spring 6.1. It is also held in a form-fitting manner in the groove-shaped recess and produces an electrical current flow between the second electrical contact element 2 and the second mandrel 5 when the second mandrel 5 has been positioned as shown in FIG. 1. In this example, the electrically conductive connection can alternatively be achieved by means of a translational movement of the second contact element 2, which is guided to such an extent that there is no longer any touching contact between the second contact element 2 and the helical spring 6.2.

It becomes clear that the windings of the helical springs 6.1 and 6.2 can be deformed in the form of an ellipse because of the pressure forces acting in relation to the axis of rotation of the contact system in the radial direction if an electrical current is to flow via the outer conductor and inner conductor.

If at least one of the mandrels 4 or 5 or the first contact element 1 or the second contact element 2 is moved in a translatory manner such that the position of the helical spring 6.1 or 6.2 is changed such that there is no touching contact with the first or second electrical contact element 1 or 2, there is a separation of the electrical current flow to an electrical load, which is connected to the mandrels 4 and 5 in an electrically conductive manner in a form not shown. Of course, the electrical contact elements 1 and 2 can also be connected in an electrically conductive manner to an electrical load and the mandrels 4 and 5 can each be connected to a pole of an electrical voltage source.

The second example shown in FIG. 2 differs from the example according to FIG. 1 in that a second insulation element 3.2 is present. This is also partially sleeve-shaped in form and provided with a circumferential flange which forms an electrical insulation between the first and second electrical contact elements 1 and 2. The sleeve-shaped region of the second insulation element 3.2 forms an electrical insulation between the first electrical contact element 1 and the first mandrel 4 in a region in which no groove-shaped recess is formed. In contrast to the example according to FIG. 1, this example has an advantageous blind assembly capability.

The first and second examples do not otherwise differ.

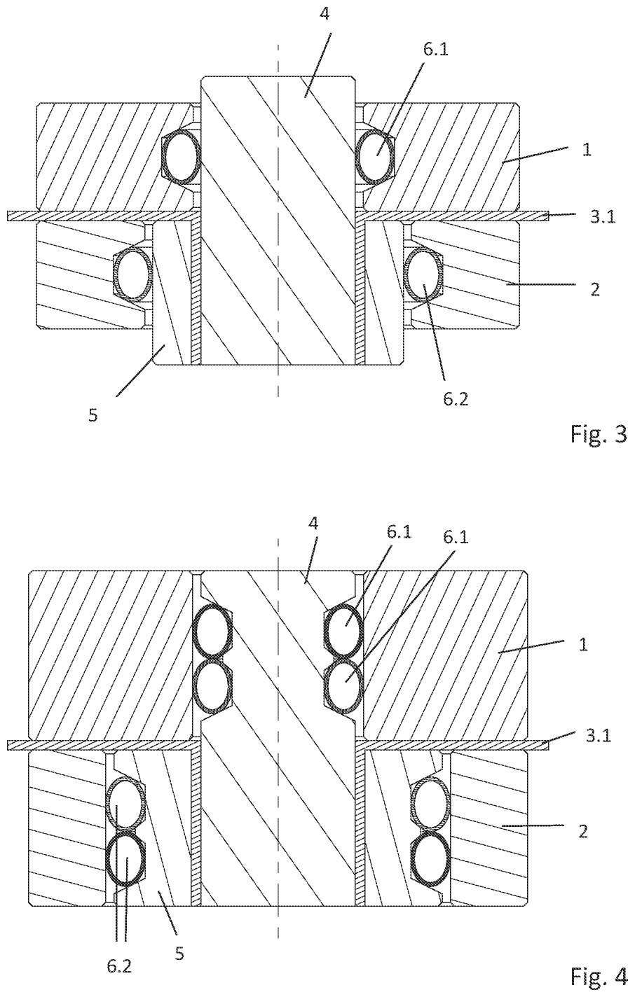

In the third example shown in FIG. 3, the position of the groove-shaped recesses for receiving the helical springs 6.1 and 6.2 is reversed compared to the two previously described examples. A groove-shaped recess for the helical spring 6.1 is formed in the inner wall of the through hole of the first electrical contact element 1 and not on a surface of the first mandrel 4 and a further groove-shaped recess is formed in the inner wall of the through hole of the second electrical contact element 2 and not on a surface of the second mandrel 5.

Further version: Groove-shaped recess both in the contact element and in the mandrel/socket (combination of FIG. 1 and FIG. 3)

The fourth example shown in FIG. 4 differs from the example according to FIG. 1 in that two groove-shaped recesses are formed, such that two helical springs 6.1 and 6.2 can respectively be inserted side by side in two grooveshaped recesses and can be fixed therein, whereby the contact points or area available for an electrical current flow is enlarged and greater electrical currents can be switched. Radially available installation space can also be better used. In a form not shown, the groove-shaped recesses can also be made longer, such that two helical springs 6.1 and 6.2 can be inserted into each groove-shaped recess.

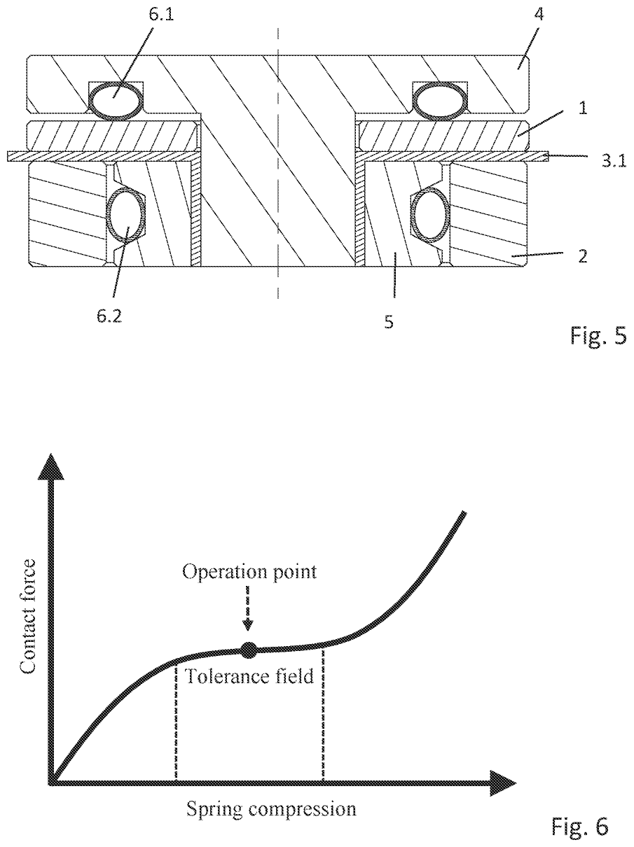

The example shown in FIG. 5 differs from the example according to FIG. 1 in that a ring-shaped, groove-shaped recess is formed on a surface of a flange formed circumferentially on the first mandrel 4. The corresponding surface points in the direction of a surface of the first electrical contact element 1. An axially tiltable or already tilted helical spring 6.1 is inserted into the grooveshaped recess, through which the electrical current flow occurs when the first mandrel 4 has been positioned, as shown in FIG. 5. This electrical current flow can be interrupted when the first mandrel 4 has been moved upwards in the form shown here, that is, away from the first electrical contact element 1.

The electrical current flow can also be interrupted when the second mandrel 5 has been moved until there is no longer any direct touching contact between the helical spring 6.2 and the second mandrel 5.

In the second example, at least one of the mandrels 4 or 5 can be moved in the through hole until there is no longer any touching contact between the helical spring 6.1 or 6.2 and the first mandrel 4 or second mandrel 5 in order to terminate the electrical current flow.

When switching on, the movement can take place in the opposite direction, such that an electrical current can flow through the electrical contact elements 1 and 2, the helical springs 6.1 and 6.2 to the mandrels 4 and 5 or vice versa.

In all examples, helical springs 6.1 and 6.2, the coils of which are oval-shaped, can be used.

1. An electrical contact arrangement having a first contact element and a second contact element, which are arranged electrically insulated from one another by means of at least one insulation element or an electrically insulating coating formed on a surface of at least one of the contact elements and
a through hole being formed in each of the first and second contact elements, into which through hole a first mandrel and a second mandrel can be inserted and
a groove-shaped recess each being formed on the first contact element and/or the first mandrel and an inner shell of the second contact element and/or an outer shell of the second mandrel, in each of which at least one ring-shaped spring element is located in a form-fitting manner and
the at least one spring-shaped spring element is formed from an electrically conductive and elastically deformable material and its inner and outer dimensions are geometrically designed and dimensioned such that the radially outward and/or the radially inward-facing wall act against the surface of a mandrel and the surface of the first and second contact element in the region of the groove-shaped recess with the application of compressive force when the first and second mandrels are inserted into the through holes to produce an electrically conductive connection and
the first electrical contact element or the first mandrel is connected to one pole of an electrical voltage source and the second electrical contact element or the second mandrel is connected to an another pole of the electrical voltage source.

2. The electrical contact arrangement according to claim 1, wherein the at least one ring-shaped spring element(s) is/are hollow in form and cylindrical having an inner and outer diameter that is constant over its/their length and a constant cross-section in an unloaded state.

3. The electrical contact arrangement according to claim 1, wherein the first and second mandrel(s) is/are designed in the form of a sleeve or socket.

4. The electrical contact arrangement according to claim 1, wherein the at least one ring-shaped spring element is a helical spring.

5. The electrical contact arrangement according to claim 1, wherein the groove-shaped recesses are dimensioned so that the at least one ring-shaped spring element(s) is/are deformed so that a spring compression of at least 10%, compared to an original state of the at least one spring-shaped spring element(s) is achieved when the first and second mandrels are inserted into the through holes of the first and second contact elements.

6. The electrical contact arrangement according to claim 1, wherein the groove-shaped recesses are formed concave, trapezoidal or as a V-shaped groove.

7. The electrical contact arrangement according to claim 1, wherein a groove-shaped recess is formed in the region an inner shell of the through hole in the first contact element.

8. The electrical contact arrangement according to claim 1, wherein when a groove-shaped recess is formed both in a mandrel and in a through hole of a contact element, one of the groove-shaped recesses of a recess pair can be dimensioned smaller than the respective other groove-shaped recess.

9. The electrical contact arrangement according to claim 1, wherein the at least one insulation element is made as a sleeve on which a radially outwardly pointing flange is present and the sleeve is arranged between an outer shell of at least one of the first and second mandrels and an inner shell in the region of one of the first and second contact elements and the flange is arranged between the first and second contact elements.

10. The electrical contact arrangement according to claim 1, wherein the first and second mandrels and the through holes formed in the first and second contact elements have a complementary cross-sectional geometry which is rotationally symmetrical, elliptical or polygonal.

11. The electrical contact arrangement according to claim 1, wherein at least one of the first and second mandrels is made in the form of a sleeve into which the other first or second mandrel and a sleeve-shaped region of the at least one insulation element is inserted.

12. The electrical contact element according to claim 1, wherein a ring-shaped groove-shaped recess is made on a surface of a flange formed circumferentially on the first mandrel, the corresponding surface points in a direction of a surface of the first contact element and a ring-shaped spring element is inserted in this groove-shaped recess.
